(19) United States
(12) Patent Application Publication
(10) Pub. No.: US 2024/0282074 A1
(43) Pub. Date: Aug. 22, 2024

(54) Accelerating Machine Vision with Peripheral and Focal Processing using Artificial Neural Networks

(71) Applicant: Micron Technology, Inc., Boise, ID (US)

(72) Inventors: Shashank Bangalore Lakshman, Folsom, CA (US); Saideep Tiku, Folsom, CA (US); Poorna Kale, Folsom, CA (US)

(21) Appl. No.: 18/415,380

(22) Filed: Jan. 17, 2024

Related U.S. Application Data
(60) Provisional application No. 63/485,480, filed on Feb. 16, 2023.

(51) Int. Cl. G06V 10/26; G06T 7/00; G06V 10/147; G06V 10/25; G06V 10/44; G06V 10/82; H04N 23/80

(52) U.S. Cl. CPC G06V 10/26; G06T 7/0004; G06V 10/147; G06V 10/25; G06V 10/449; G06V 10/82; H04N 23/80; G06T 2207/30108

(57) ABSTRACT

Different machine vision acuity levels for anomaly detection in an image. An image sensing pixel array generates image data representative of the image having a first region (e.g., focal region) and a second region (e.g. periphery). A memory cell array stores a first weight matrix representative of a first kernel of a convolutional neural network and a second weight matrix representative of a second kernel. A logic circuit can apply the first kernel to the first region using the first weight matrix to generate first feature data at a first stride length with quantization at a first precision level. The logic circuit can apply the second kernel to the second region using the second weight matrix to generate second feature data at a second stride length with quantization at a second precision level.

### RELATED APPLICATIONS

The present application claims priority to Prov. U.S. Pat. App. Ser. No. 63/485,480 filed Feb. 16, 2023, the entire disclosures of which application are hereby incorporated herein by reference.

### TECHNICAL FIELD

At least some embodiments disclosed herein relate to storage and processing of data in general and more particularly, but not limited to, image data for feature extraction.

### BACKGROUND

High-resolution image sensors can generate large amounts of data. Transmitting the entire set of data of an image from a digital camera to a server for processing and storage can be inefficient.

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 and FIG. 2 illustrate a technique to process image data in a peripheral region with less intensity than processing image data in a focal region to improve efficiency according to one embodiment.

FIG. 3 shows an edge application configured to extract features from images of products on a production line for inspection according to one embodiment.

FIG. 4 shows an integrated circuit device having an image sensing pixel array, a memory cell array, and circuits to perform inference computations according to one embodiment.

FIG. 5 and FIG. 6 illustrate different configurations of integrated imaging and inference devices according to some embodiments.

FIG. 7 shows the computation of a column of weight bits multiplied by a column of input bits to provide an accumulation result according to one embodiment.

FIG. 8 shows the computation of a column of multi-bit weights multiplied by a column of input bits to provide an accumulation result according to one embodiment.

FIG. 9 shows the computation of a column of multi-bit weights multiplied by a column of multi-bit inputs to provide an accumulation result according to one embodiment.

FIG. 10 shows a computing system configured to process an image using an integrated circuit device and an artificial neural network according to one embodiment.

FIG. 11 shows another computing system according to one embodiment.

FIG. 12 shows an implementation of artificial neural network computations according to one embodiment.

FIG. 13 shows an image processing logic circuit using an inference logic circuit in image compression according to one embodiment.

FIG. 14 shows a method of image processing according to one embodiment.

### DETAILED DESCRIPTION

At least some embodiments disclosed herein provide techniques of processing peripheral and focal image regions differently for reduced latency, energy consumption, and communication bandwidth usage.

Human vision can provide the highest visual acuity in the center region known as fovea, in which retinal cones have the highest concentration. In the periphery, retinal cones have reduced concentration to provide peripheral vision at lower visual acuity. Retinal ganglion cells located near the inner surface of the retina receive visual information from retinal cones, encode the received information, and transmit the encoded information from the eye to the brain.

Techniques of processing peripheral and focal image regions differently can be used to emulate the high visual acuity of the focal vision and the reduced visual acuity of the peripheral vision. The reduced visual acuity for the peripheral vision can accelerate machine vision applications, and reduce energy consumption. The processing of image regions to extract features can be implemented in an edge server configured near the image sensor to reduce the communication bandwidth usage in communication with a server computer.

For example, machine vision can be used to drive real-time decision making in manufacturing processes, such as inspection of parts and packaging, detection of visible anomalies and defects, etc. In such applications, low visual acuity in the periphery of gaze can be acceptable for many vision-based tasks.

For example, the relative positions of the camera and the object of interest are fixed on a production line or assembly line. The focal region of high interest and periphery of low interest can be predefined for the images captured by the camera. It can be advantageous to reduce the machine vision acuity in the periphery of low interest without reducing the machine vision acuity in the focal region of high interest.

Reducing the acuity of machine vision in the periphery can reduce the latency in processing an image captured by a camera, enable real-time decisions (e.g., in detecting visible anomalies and defects), and reduce energy consumption. When the machine vision computation is implemented in an edge server configured at or near the camera, the communication bandwidth usage for communicating camera inputs to a central server system can be reduced.

For example, a digital camera can be configured to capture an image of a product going through a production line or assembly line at a uniform resolution suitable for fine-grained analysis. A mask can be predefined to identify a focal region within the image. The timing of capturing the image of the product on the production line can be controlled (e.g., via detection of the position of the product on the production line or assembly line) such that a portion of the product to be inspected is shown in the image within the focal region. A coarse-grained analysis can be applied to the periphery outside of the focal region in the image. A fine-grained analysis of the focal region defined by the mask can be performed using a kernel of a convolutional neural network having a small kernel size, applied with a small stride length, and/or quantized at a high precision level. A coarse-grained analysis of the periphery can be performed using a kernel having a large kernel size, applied with a large stride length, and/or quantized at a low precision.

Using the coarse-grained analysis for the periphery can reduce the latency of the analysis of the entire image captured by the digital camera, enable faster deep neural network interface, reduce processing power requirement for an edge server configured near the digital camera, reducing power consumption of the edge server, etc.

In one embodiment, each layer of a deep neural network is configured with multiple convolutional kernel sizes. Larger convolutional kernels are used in the periphery for coarse-grained search of non-critical anomalies, while smaller convolutional kernels are used in the focal region for fine-grained search of critical anomalies. A larger stride length is used in the periphery for coarse-grained search for non-critical anomalies, while a smaller stride length is used in the focal region for fine-grained search of critical anomalies. For example, the color channels can be optionally reduced for peripheral, coarse-grained search of non-critical anomalies, while full color channels are used in the focal region for fine-grained search of critical anomalies. For example, the input and weight data used in the analysis of the peripheral can be quantized at a level having a low precision to reduce computation workload and energy consumption, while the data for the focal region analysis can be quantized at another level having a high precision. Optionally, spatial kernel pruning can be applied to improve regularization in periphery (e.g., to avoid few pixels from controlling peripheral vision decisions).

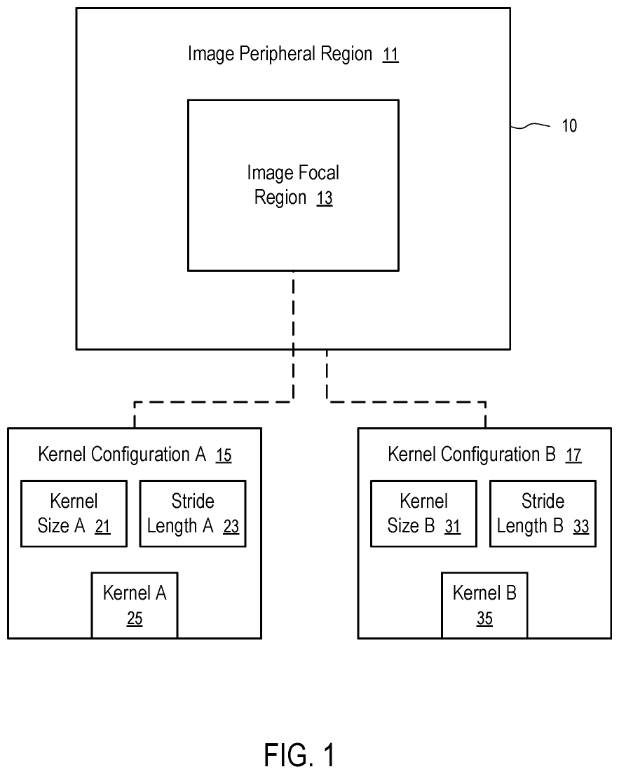

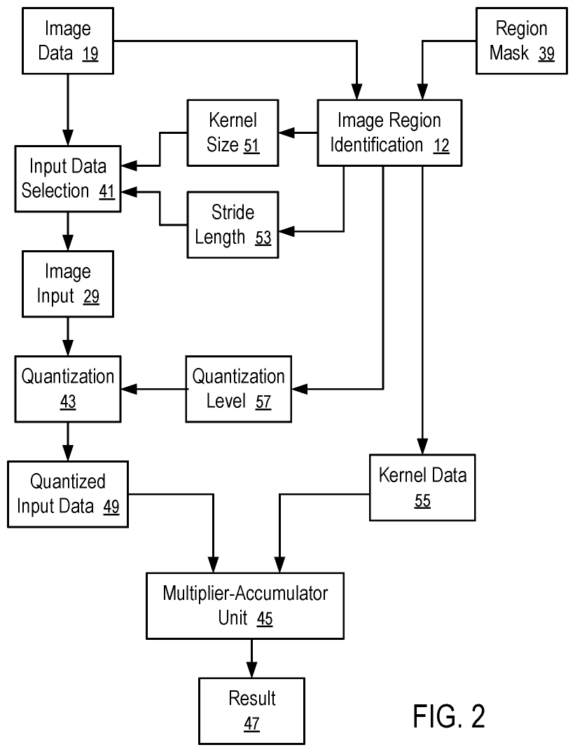

FIG. 1 and FIG. 2 illustrate a technique to process image data in a peripheral region with less intensity than processing image data in a focal region to improve efficiency according to one embodiment.

In FIG. 1, an image 10 is partitioned into a focal region 13 and a peripheral region 11. For example, a mask can be used to define which pixel of the image 10 is classified in which region (e.g., 11 or 13).

Different kernel configurations 15 and 17 can be specified for the analyses of the respective regions 11 and 13 using a layer of convolutional neural network.

A kernel of a convolutional neural network functions as a filter used to extract features from an image. The kernel can be configured in the form of a weight matrix of a predetermined size. The data of a block of pixels of a corresponding size in the image can be used as an input to be filtered by the kernel. A dot product between the data of the pixel block and the weight matrix provides a result representative of a feature. The application of the filter on the image can move from one block of pixels to a next block of pixels that has an offset from the previous block according to a stride length. The stride length can be configured such that the successive blocks being filtered by the kernel can have an overlapping area.

For example, the image data in the focal region 13 can be configured to be filtered using one kernel 25 having a small kernel size 21 to extract fine features for a fine-grained analysis, while the image data in the peripheral region 11 can be configured to be filtered using another kernel 35 having a large kernel size 31 to coarse features for a coarse-grained analysis. The application of the kernel 25 to the focal region can be configured at a small stride length 23, while the application of the kernel 35 to the peripheral region 11 can be configured at a large stride.

FIG. 1 illustrates an example of dividing an image 10 into two regions 11 and 13 with respective kernel configurations 15 and 17. In general, an image 10 can be divided into more than two regions, each configured to be processed using a separate kernel with a customized kernel size and stride length.

FIG. 2 illustrates the application of different kernels to an image to extract features according to a region mask 39.

The region mask 39 is configured to specify, for each pixel in an image 10, an identification 12 of an image region (e.g., 11 or 13) that has an associated kernel configuration (e.g., 17 or 15).

For the image data 19 of a set of pixels having a same image region identification 12, an associated kernel configuration (e.g., 15 or 17) is used to identify the kernel data 55, kernel size 51, and strike length 53 for the filtering of the image data 19.

For example, when the image region identification 12 indicates that the image data 19 is for a focal region 13, a kernel configuration 15 is selected; and the kernel 25, kernel size 21, and stride length 23 of the configuration 15 are retrieved as the kernel data 55, the kernel size 51, and the strike length 53.

For example, when the image region identification 12 indicates that the image data 19 is for a peripheral region 11, a kernel configuration 17 is selected; and the kernel 35, kernel size 31, and stride length 33 of the configuration 17 are retrieved as the kernel data 55, the kernel size 51, and the strike length 53.

Based on the kernel size 51 and the strike length 53, input data selection 41 is performed to select a block of pixels from the image data 19 as the image input 29 for multiplication and accumulation with the kernel data 55.

Optionally, the image region identification 12 is further used to determine a quantization level 57 for the image input 29.

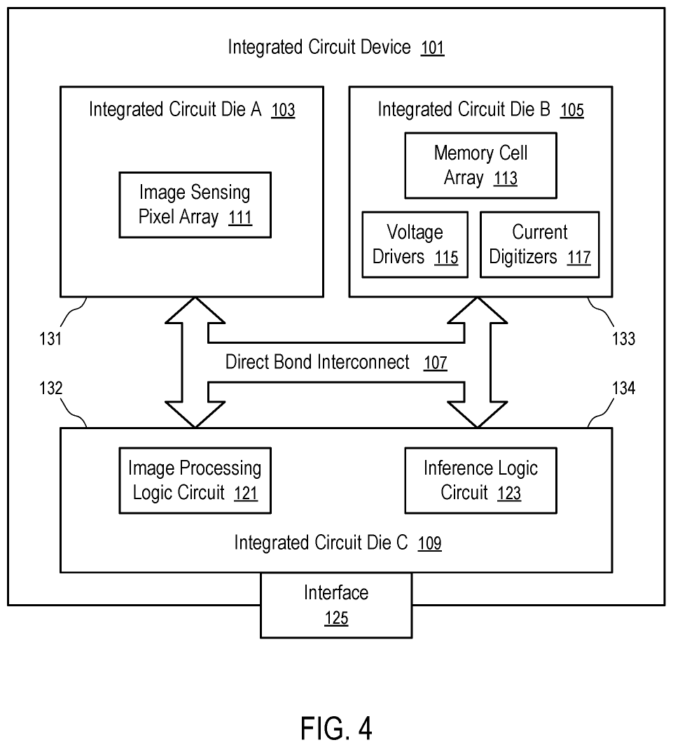

For example, when the image data 19 is in the focal region 13, the image input 29 can be quantized at a high precision level; and when the image data 19 is in the peripheral region 11, the image input 29 can be quantized at a low precision level. For example, each pixel value in the focal region 13 can be transformed to be represented using a first number of bits that is larger than a second number of bits used to represent a corresponding pixel value in the peripheral region 11. Reducing the quantization precision levels can reduce the computing workload and the energy consumption in a multiplier-accumulator unit 45 in computing the dot product between the kernel data 55 and the quantized input data 49, such as a multiplier-accumulator unit 270 implemented using a synapse memory cell array 113, as in FIG. 4 to FIG. 11.

Quantized input data 49 is obtained from quantization 43 of the image input 29 according to the quantization level 57.

Optionally, the kernel data 55 is pre-quantized according to the quantization level 57. Alternatively, quantization of the kernel data 55 can be performed at the quantization level 57 determined from the image region identification 12.

The multiplier-accumulator unit 45 applies the quantized input data 49 to the kernel data 55 via multiplication and accumulation operations to obtain a result 47 representative of a feature extracted from the image input 29 using the kernel data 55.

The kernel size 51 and the stride length 53 can be used in the input data selection 41 to identify different blocks of pixels in the image data 19. Each block of pixels can be an image input 29 to be filtered by the kernel data 55 for feature extraction. Applying the kernel data 55 to the blocks of pixels can generate a set of features that can be further analyzed using artificial neurons.

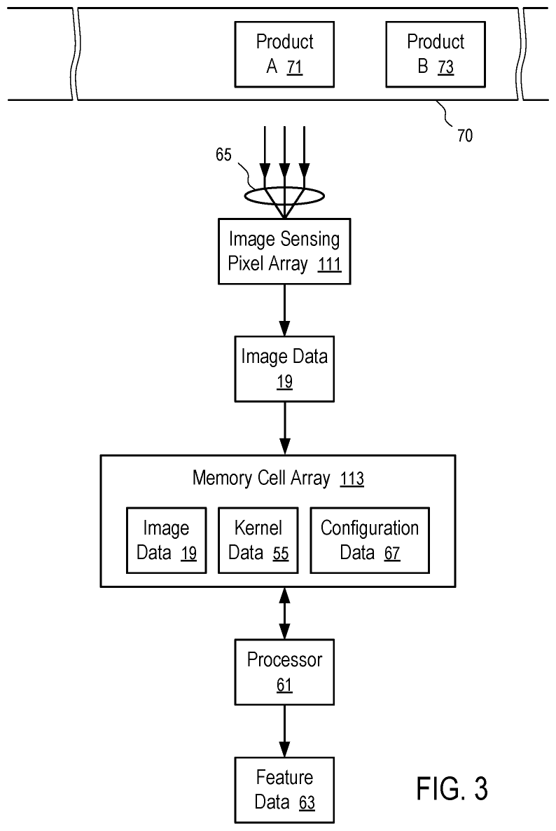

FIG. 3 shows an edge application configured to extract features from images of products on a production line for inspection according to one embodiment. For example, the techniques of FIG. 1 and FIG. 2 to apply different kernel configurations (e.g., 15, 17) to different image regions (e.g., 13, 11) for feature extraction can be implemented in the edge application of FIG. 3.

In FIG. 3, a lens 65 is configured to project an image 10 of a scene onto an image sensing pixel array 111. The scene can include a portion of a production line 70 having products (e.g., 71, 73) being moved into and through the field of view of the lens 65. The capturing of an image 10 can be synchronized with the detection of the arrival of a product (e.g., 71) at a pre-selected position. For example, the products (e.g., 71, 73) can be transported through the field of view of the lens 65 using a belt conveyor system; and the arrival of the product (e.g., 71) at a pre-selected position can be detected via a light source (e.g., light-emitting diode (LED)) sending a light beam towards the photodetector across the conveyor belt. The obstruction of the light beam by a product 71 can be detected by the photodetector to identify position of the product 71. Alternative position determination systems can also be used.

The image 10 as captured by the image sensing pixel array 111 can be analyzed according to the region mask 39 as in FIG. 2 to generate filtering results of applying kernel data 55 to image inputs (e.g., 29) selected from the image data 19 of the image 10.

For example, to generate feature data 63 from the image data 19, a processor 81 is configured to apply different kernels (e.g., 25, 35) to different regions of the image 10. The feature data 63 can be transmitted to a server computer for anomaly detection. Alternatively, the processor 61 can be further configured to perform the anomaly detection (e.g., using layers of artificial neurons).

Optionally, the processor 61 can be configured in the digital camera having the image sensing pixel array 111 for edge processing. For example, the processor 61 can be implemented via an image processing circuit or a microprocessor connected locally to the memory cell array 113 via a high speed interconnect or computer bus. For example, the processor 61, the memory cell array 113, and the image sensing pixel array 111 can be configured as a digital camera.

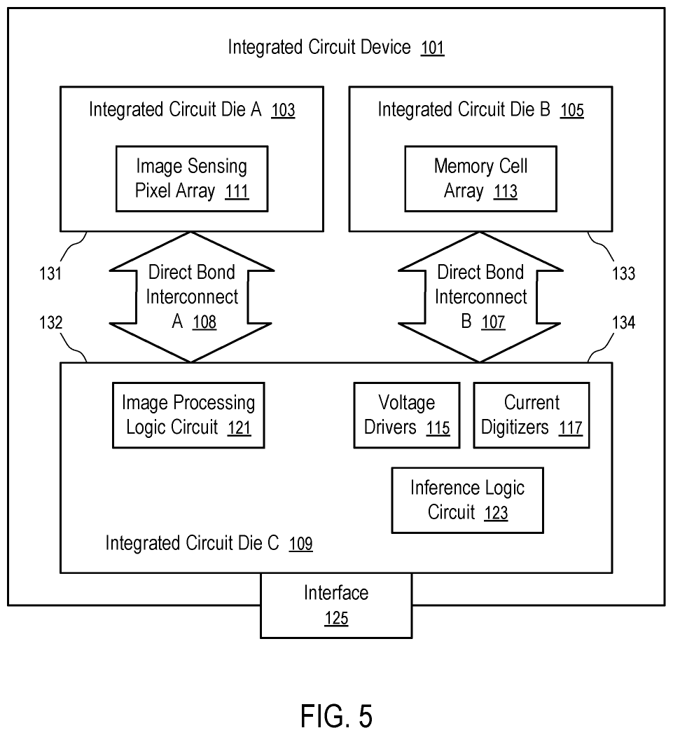

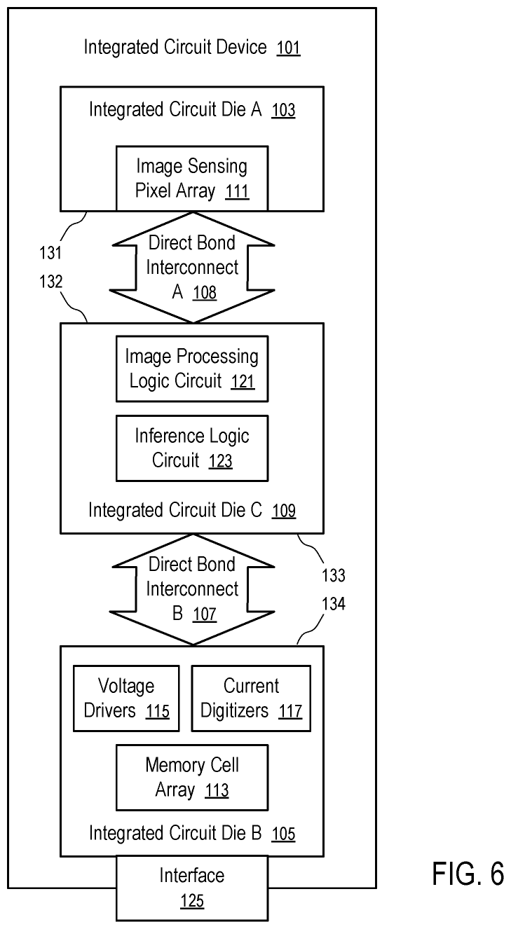

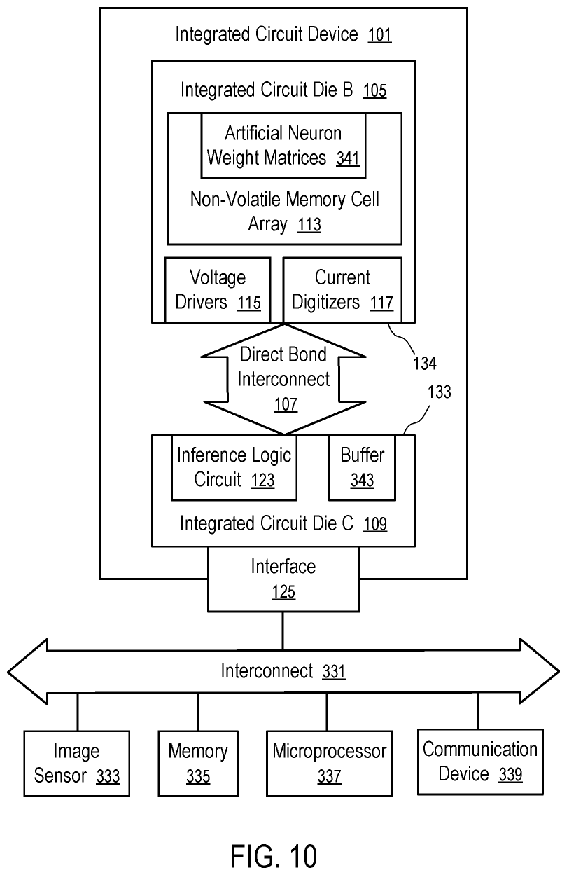

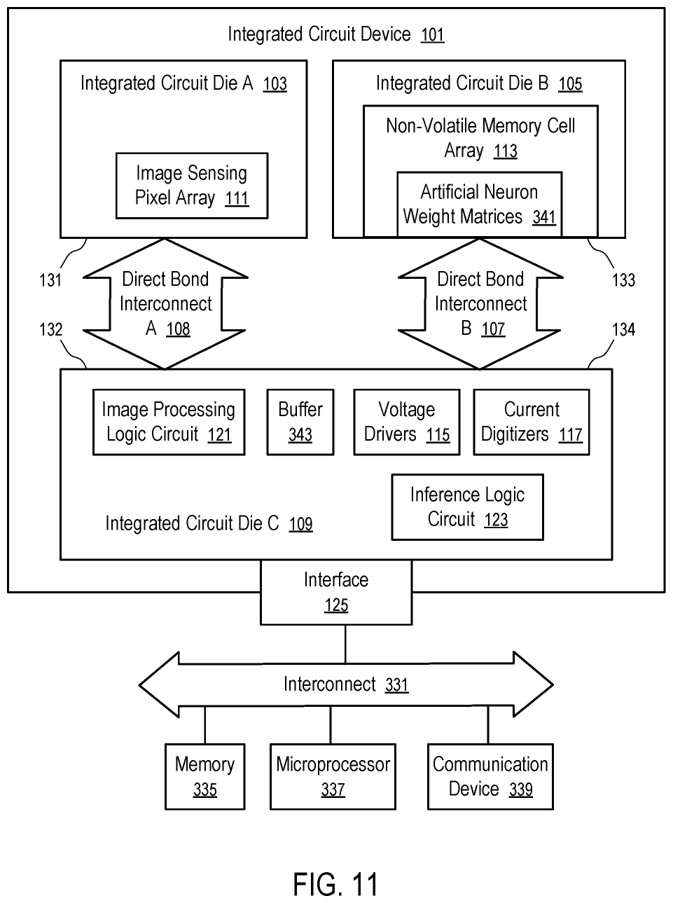

In some implementations, the processor 61 is configured via an inference logic circuit 123 packaged in a same integrated circuit device 101 as in FIG. 4, FIG. 5, FIG. 6, FIG. 10, and FIG. 11. In other implementations, the processor 61 is implemented at least in part using a microprocessor 337 connected with an image sensor 333 as in FIG. 10, or connected with an integrated circuit device 101 as in FIG. 11.

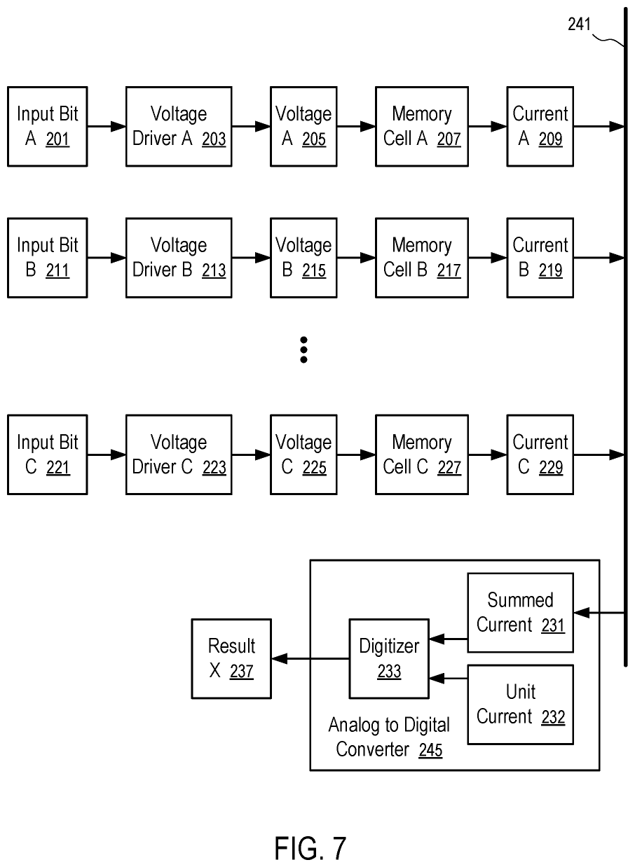

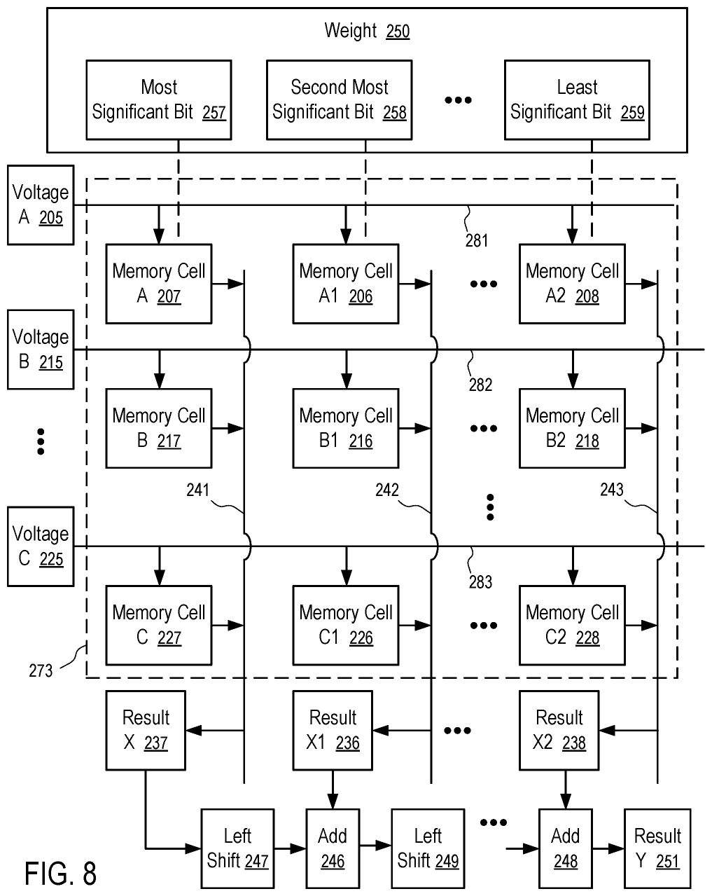

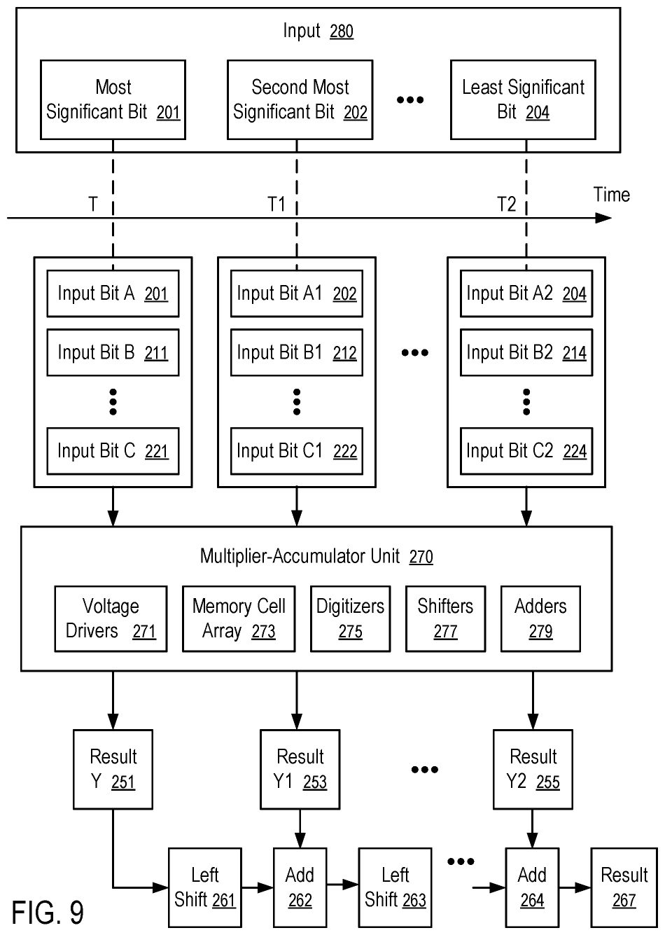

The memory cell array 113 can store kernel data 55 in the form of weight matrices in a synapse mode configured to support operations of multiplication and accumulation, as further discussed below in FIG. 7, FIG. 8, and FIG. 9. During multiplication and accumulation operations, a controller coupled to the memory cell array 113 can use voltage drivers to apply read voltages, according to input data, onto wordlines connected to memory cells programmed in the synapse mode to generate currents representative of results of multiplications between the weight data and the input data. The currents are summed in an analog form in bitlines connected to the memory cells programmed in the synapse mode. Current digitizers can convert the currents summed in bitlines to digital results. A portion of the memory cell array 113 can be programmed in a storage mode to store the image data 19. Memory cells programmed in the storage mode can have better performance in data storage and data retrieval than memory cells programmed in the synapse mode, but can lack the support for multiplication and accumulation operations.

The memory cell array 113 can store configuration data 67 (e.g., kernel configurations 15 and 17, and region mask 39). The kernel data 55 can be selected from the configuration data 67 for application to blocks of pixels in the image data 19, based on the image region identifications 12 of the blocks.

In other implementations, the processor 61 is remote to the memory cell array 113 and the image sensing pixel array 111. For example, the processor 61 can access the image data 90 via a computer network or a telecommunications network. However, communicating the image data 19 across the computer network or the telecommunications network to extract the feature data 63 can be inefficient. It is advantageous to extract the feature data 63 near the memory cell array 113 and communicate the feature data 63 to the processor 61 over the computer network or the telecommunications network for anomaly detection to reduce the usage of communication bandwidth.

Optionally, the image sensing pixel array 111 and the memory cell array 113 can be integrated in an integrated circuit device in FIG. 4, FIG. 5, and FIG. 6. The integrated circuit device can be configured with an analog capability to support inference computations, such as computations of multiplication and accumulation, and computations of an artificial neural network. In such an integrated circuit device, an image sensor chip containing the image sensing pixel array 111 and a memory chip containing the memory cell array 113 can be bonded to a logic wafer containing logic circuits to facilitate the computations of multiplication and accumulation, and computations of an artificial neural network having an image as an input, to perform image enhancement, to perform image compression, etc.

For example, the memory chip can be connected directly to a portion of the logic wafer via heterogeneous direct bonding, also known as hybrid bonding or copper hybrid bonding.

Direct bonding is a type of chemical bond between two surfaces of material meeting various requirements. Direct bonding of wafers typically includes pre-processing wafers, pre-bonding the wafers at room temperature, and annealing at elevated temperatures. For example, direct bonding can be used to join two wafers of a same material (e.g., silicon); anodic bonding can be used to join two wafers of different materials (e.g., silicon and borosilicate glass); eutectic bonding can be used to form a bonding layer of eutectic alloy based on silicon combining with metal to form a eutectic alloy.

Hybrid bonding can be used to join two surfaces having metal and dielectric material to form a dielectric bond with an embedded metal interconnect from the two surfaces. The hybrid bonding can be based on adhesives, direct bonding of a same dielectric material, anodic bonding of different dielectric materials, eutectic bonding, thermocompression bonding of materials, or other techniques, or any combination thereof.

Copper microbump is a traditional technique to connect dies at packaging level. Tiny metal bumps can be formed on dies as microbumps and connected for assembling into an integrated circuit package. It is difficult to use microbumps for high density connections at a small pitch (e.g., 10 micrometers). Hybrid bonding can be used to implement connections at such a small pitch not feasible via microbumps.

The image sensor chip can be configured on another portion of the logic wafer and connected via hybrid bonding (or a more conventional approach, such as microbumps).

In one configuration, the image sensor chip and the memory chip are placed side by side on the top of the logic wafer. Alternatively, the image sensor chip is connected to one side of the logic wafer (e.g., top surface); and the memory chip is connected to the other side of the logic wafer (e.g., bottom surface).

The logic wafer has a logic circuit configured to process images from the image sensor chip, and another logic circuit configured to operate the memory cells in the memory chip to perform multiplications and accumulation operations.

The memory chip can have multiple layers of memory cells. Each memory cell can be programmed to store a bit of a binary representation of an integer weight. Each input line can be applied a voltage according to a bit of an integer. Columns of memory cells can be used to store bits of a weight matrix; and a set of input lines can be used to control voltage drivers to apply read voltages on rows of memory cells according to bits of an input vector.

The threshold voltage of a memory cell used for multiplication and accumulation operations can be programmed in a synapse mode such that the current going through the memory cell subjecting to a predetermined read voltage is either a predetermined amount representing a value of one stored in the memory cell, or negligible to represent a value of zero stored in the memory cell. When the predetermined read voltage is not applied, the current going through the memory cell is negligible regardless of the value stored in the memory cell. As a result of the configuration, the current going through the memory cell corresponds to the result of 1-bit weight, as stored in the memory cell, multiplied by 1-bit input, corresponding to the presence or the absence of the predetermined read voltage driven by a voltage driver controlled by the 1-bit input. Output currents of the memory cells, representing the results of a column of 1-bit weights stored in the memory cells and multiplied by a column of 1-bit inputs respectively, are connected to a common line for summation. The summed current in the common line is a multiple of the predetermined amount; and the multiples can be digitized and determined using an analog to digital converter. Such results of 1-bit to 1-bit multiplications and accumulations can be performed for different significant bits of weights and different significant bits of inputs. The results for different significant bits can be shifted to apply the weights of the respective significant bits for summation to obtain the results of multiplications of multi-bit weights and multi-bit inputs with accumulation, as further discussed below.

Using the capability of performing multiplication and accumulation operations implemented via memory cell arrays, the logic circuit in the logic wafer can be configured to perform inference computations, such as the computation of an artificial neural network.

FIG. 4 shows an integrated circuit device 101 having an image sensing pixel array 111, a memory cell array 113, and circuits to perform inference computations according to one embodiment.

In FIG. 4, the integrated circuit device 101 has an integrated circuit die 109 having logic circuits 121 and 123, an integrated circuit die 103 having the image sensing pixel array 111, and an integrated circuit die 105 having a memory cell array 113.

The integrated circuit die 109 having logic circuits 121 and 123 can be considered a logic chip; the integrated circuit die 103 having the image sensing pixel array 111 can be considered an image sensor chip; and the integrated circuit die 105 having the memory cell array 113 can be considered a memory chip.

In FIG. 4, the integrated circuit die 105 having the memory cell array 113 further includes voltage drivers 115 and current digitizers 117. The memory cell array 113 are connected such that currents generated by the memory cells in response to voltages applied by the voltage drivers 115 are summed in the array 113 for columns of memory cells (e.g., as illustrated in FIG. 7 and FIG. 8); and the summed currents are digitized to generate the sum of bit-wise multiplications. The inference logic circuit 123 can be configured to instruct the voltage drivers 115 to apply read voltages according to a column of inputs, perform shifts and summations to generate the results of a column or matrix of weights multiplied by the column of inputs with accumulation.

The inference logic circuit 123 can be further configured to perform inference computations according to weights stored in the memory cell array 113 (e.g., the computation of an artificial neural network) and inputs derived from the image data generated by the image sensing pixel array 111. Optionally, the inference logic circuit 123 can include a programmable processor that can execute a set of instructions to control the inference computation. Alternatively, the inference computation is configured for a particular artificial neural network with certain aspects adjustable via weights stored in the memory cell array 113. Optionally, the inference logic circuit 123 is implemented via an application-specific integrated circuit (ASIC), a field-programmable gate array (FPGA), or a core of a programmable microprocessor.

In FIG. 4, the integrated circuit die 105 having the memory cell array 113 has a bottom surface 133; and the integrated circuit die 109 having the inference logic circuit 123 has a portion of a top surface 134. The two surfaces 133 and 134 can be connected via hybrid bonding to provide a portion of a direct bond interconnect 107 between the metal portions on the surfaces 133 and 134.

Similarly, the integrated circuit die 103 having the image sensing pixel array 111 has a bottom surface 131; and the integrated circuit die 109 having the inference logic circuit 123 has another portion of its top surface 132. The two surfaces 131 and 132 can be connected via hybrid bonding to provide a portion of the direct bond interconnect 107 between the metal portions on the surfaces 131 and 132.

An image sensing pixel in the array 111 can include a light sensitive element configured to generate a signal responsive to intensity of light received in the element. For example, an image sensing pixel implemented using a complementary metal-oxide-semiconductor (CMOS) technique or a charge-coupled device (CCD) technique can be used.

In some implementations, the image processing logic circuit 121 is configured to pre-process an image from the image sensing pixel array 111 to provide a processed image as an input to the inference computation controlled by the inference logic circuit 123.

Optionally, the image processing logic circuit 121 can also use the multiplication and accumulation function provided via the memory cell array 113.

In some implementations, the direct bond interconnect 107 includes wires for writing image data from the image sensing pixel array 111 to a portion of the memory cell array 113 for further processing by the image processing logic circuit 121 or the inference logic circuit 123, or for retrieval via an interface 125.

The inference logic circuit 123 can buffer the result of inference computations in a portion of the memory cell array 113.

The interface 125 of the integrated circuit device 101 can be configured to support a memory access protocol, or a storage access protocol or any combination thereof. Thus, an external device (e.g., a processor, a central processing unit) can send commands to the interface 125 to access the storage capacity provided by the memory cell array 113.

For example, the interface 125 can be configured to support a connection and communication protocol on a computer bus, such as a peripheral component interconnect express (PCIe) bus, a serial advanced technology attachment (SATA) bus, a universal serial bus (USB) bus, a compute express link, etc. In some embodiments, the interface 125 can be configured to include an interface of a solid-state drive (SSD), such as a ball grid array (BGA) SSD. In some embodiments, the interface 125 is configured to include an interface of a memory module, such as a double data rate (DDR) memory module, a dual in-line memory module, etc. The interface 125 can be configured to support a communication protocol such as a protocol according to non-volatile memory express (NVMe), non-volatile memory host controller interface specification (NVMHCIS), etc.

The integrated circuit device 101 can appear to be a memory sub-system from the point of view of a device in communication with the interface 125. Through the interface 125 an external device (e.g., a processor, a central processing unit) can access the storage capacity of the memory cell array 113. For example, the external device can store and update weight matrices and instructions for the inference logic circuit 123, retrieve images generated by the image sensing pixel array 111 and processed by the image processing logic circuit 121, and retrieve results of inference computations controlled by the inference logic circuit 123.

In some implementations, some of the circuits (e.g., voltage drivers 115, or current digitizers 117, or both) are implemented in the integrated circuit die 109 having the inference logic circuit 123, as illustrated in FIG. 5.

In FIG. 4, the image sensor chip and the memory chip are placed side by side on the same side (e.g., top side) of the logic chip. Alternatively, the image sensor chip and the memory chip can be placed on different sides (e.g., top surface and bottom surface) of the logic chip, as illustrated in FIG. 6.

FIG. 5 and FIG. 6 illustrate different configurations of integrated imaging and inference devices according to some embodiments.

Similar to the integrated circuit device 101 of FIG. 4, the device 101 in FIG. 5 and FIG. 6 can also have an integrated circuit die 109 having image processing logic circuits 121 and inference logic circuit 123, an integrated circuit die 103 having an image sensing pixel array 111, and an integrated circuit die 105 having a memory cell array 113.

However, in FIG. 5, the voltage drivers 115 and current digitizers 117 are configured in the integrated circuit die 109 having the inference logic circuit 123. Thus, the integrated circuit die 105 of the memory cell array 113 can be manufactured to contain memory cells and wire connections without added complications of voltage drivers 115 and current digitizers 117.

In FIG. 5, a direct bond interconnect 108 connects the image sensing pixel array 111 to the image processing logic circuit 121. Alternatively, microbumps can be used to connect the image sensing pixel array 111 to the image processing logic circuit 121.

In FIG. 5, another direct bond interconnect 107 connects the memory cell array 113 to the voltage drivers 115 and the current digitizers 117. Since the direct bond interconnects 107 and 108 are separate from each other, the image sensor chip may not write image data directly into the memory chip without going through the logic circuits in the logic chip. Alternatively, a direct bond interconnect 107 as illustrated in FIG. 4 can be configured to allow the image sensor chip to write image data directly into the memory chip without going through the logic circuits in the logic chip.

Optionally, some of the voltage drivers 115, the current digitizers 117, and the inference logic circuits 123 can be configured in the memory chip, while the remaining portion is configured in the logic chip.

FIG. 4 and FIG. 5 illustrate configurations where the memory chip and the image sensor chip are placed side-by-side on the logic chip. During manufacturing of the integrated circuit devices 101, memory chips and image sensor chips can be placed on a surface of a logic wafer containing the circuits of the logic chips to apply hybrid bonding. The memory chips and image sensor chips can be combined to the logic wafer at the same time. Subsequently, the logic wafer having the attached memory chips and image sensor chips can be divided into chips of the integrated circuit devices (e.g., 101).

Alternatively, as in FIG. 6, the image sensor chip and the memory chip are placed on different sides of the logic chip.

In FIG. 6, the image sensor chip is connected to the logic chip via a direct bond interconnect 108 on the top surface 132 of the logic chip. Alternatively, microbumps can be used to connect the image sensor chip to the logic chip. The memory chip is connected to the logic chip via a direct bond interconnect 107 on the bottom surface 133 of the logic chip. During the manufacturing of the integrated circuit devices 101, an image sensor wafer can be attached to, bonded to, or combined with the top surface of the logic wafer in a process/operation; and the memory wafer can be attached to, bonded to, or combined with the bottom side of the logic wafer in another process. The combined wafers can be divided into chips of the integrated circuit devices 101.

FIG. 6 illustrates a configuration in which the voltage drivers 115 and current digitizers 117 are configured in the memory chip having the memory cell array 113. Alternatively, some of the voltage drivers 115, the current digitizers 117, and the inference logic circuit 123 are configured in the memory chip, while the remaining portion is configured in the logic chip disposed between the image sensor chip and the memory chip. In other implementations, the voltage drivers 115, the current digitizers 117, and the inference logic circuit 123 are configured in the logic chip, in a way similar to the configuration illustrated in FIG. 5.

In FIG. 4, FIG. 5, and FIG. 6, the interface 125 is positioned at the bottom side of the integrated circuit device 101, while the image sensor chip is positioned at the top side of the integrated device 101 to receive incident light for generating images.

The voltage drivers 115 in FIG. 4, FIG. 5, and FIG. 6 can be controlled to apply voltages to program the threshold voltages of memory cells in the array 113. Data stored in the memory cells can be represented by the levels of the programmed threshold voltages of the memory cells.

A typical memory cell in the array 113 has a nonlinear current to voltage curve. When the threshold voltage of the memory cell is programmed to a first level to represent a stored value of one, the memory cell allows a predetermined amount of current to go through when a predetermined read voltage higher than the first level is applied to the memory cell. When the predetermined read voltage is not applied (e.g., the applied voltage is zero), the memory cell allows a negligible amount of current to go through, compared to the predetermined amount of current. On the other hand, when the threshold voltage of the memory cell is programmed to a second level higher than the predetermined read voltage to represent a stored value of zero, the memory cell allows a negligible amount of current to go through, regardless of whether the predetermined read voltage is applied. Thus, when a bit of weight is stored in the memory as discussed above, and a bit of input is used to control whether to apply the predetermined read voltage, the amount of current going through the memory cell as a multiple of the predetermined amount of current corresponds to the digital result of the stored bit of weight multiplied by the bit of input. Currents representative of the results of 1-bit by 1-bit multiplications can be summed in an analog form before digitized for shifting and summing to perform multiplication and accumulation of multi-bit weights against multi-bit inputs, as further discussed below.

FIG. 7 shows the computation of a column of weight bits multiplied by a column of input bits to provide an accumulation result according to one embodiment.

In FIG. 7, a column of memory cells 207, 217, . . . , 227 (e.g., in the memory cell array 113 of an integrated circuit device 101) can be programmed to have threshold voltages at levels representative of weights stored one bit per memory cell.

Voltage drivers 203, 213, . . . , 223 (e.g., in the voltage drivers 115 of an integrated circuit device 101) are configured to apply voltages 205, 215, . . . , 225 to the memory cells 207, 217, . . . , 227 respectively according to their received input bits 201, 211, . . . , 221.

For example, when the input bit 201 has a value of one, the voltage driver 203 applies the predetermined read voltage as the voltage 205, causing the memory cell 207 to output the predetermined amount of current as its output current 209 if the memory cell 207 has a threshold voltage programmed at a lower level, which is lower than the predetermined read voltage, to represent a stored weight of one, or to output a negligible amount of current as its output current 209 if the memory cell 207 has a threshold voltage programmed at a higher level, which is higher than the predetermined read voltage, to represent a stored weight of zero. However, when the input bit 201 has a value of zero, the voltage driver 203 applies a voltage (e.g., zero) lower than the lower level of threshold voltage as the voltage 205 (e.g., does not apply the predetermined read voltage), causing the memory cell 207 to output a negligible amount of current at its output current 209 regardless of the weight stored in the memory cell 207. Thus, the output current 209 as a multiple of the predetermined amount of current is representative of the result of the weight bit, stored in the memory cell 207, multiplied by the input bit 201.

Similarly, the current 219 going through the memory cell 217 as a multiple of the predetermined amount of current is representative of the result of the weight bit, stored in the memory cell 217, multiplied by the input bit 211; and the current 229 going through the memory cell 227 as a multiple of the predetermined amount of current is representative of the result of the weight bit, stored in the memory cell 227, multiplied by the input bit 221.

The output currents 209, 219, . . . , and 229 of the memory cells 207, 217, . . . , 227 are connected to a common line 241 for summation. The summed current 231 is compared to the unit current 232, which is equal to the predetermined amount of current, by a digitizer 233 of an analog to digital converter 245 to determine the digital result 237 of the column of weight bits, stored in the memory cells 207, 217, . . . , 227 respectively, multiplied by the column of input bits 201, 211, . . . , 221 respectively with the summation of the results of multiplications.

The sum of negligible amounts of currents from memory cells connected to the line 241 is small when compared to the unit current 232 (e.g., the predetermined amount of current). Thus, the presence of the negligible amounts of currents from memory cells does not alter the result 237 and is negligible in the operation of the analog to digital converter 245.

In FIG. 7, the voltages 205, 215, . . . , 225 applied to the memory cells 207, 217, 227 are representative of digitized input bits 201, 211, . . . , 221; the memory cells 207, 217, . . . , 227 are programmed to store digitized weight bits; and the currents 209, 219, . . . , 229 are representative of digitized results. Thus, the memory cells 207, 217, . . . , 227 do not function as memristors that convert analog voltages to analog currents based on their linear resistances over a voltage range; and the operating principle of the memory cells in computing the multiplication is fundamentally different from the operating principle of a memristor crossbar. When a memristor crossbar is used, conventional digital to analog converters are used to generate an input voltage proportional to inputs to be applied to the rows of memristor crossbar. When the technique of FIG. 7 is used, such digital to analog converters can be eliminated; and the operation of the digitizer 233 to generate the result 237 can be greatly simplified. The result 237 is an integer that is no larger than the count of memory cells 207, 217, . . . , 227 connected to the line 241. The digitized form of the output currents 209, 219, . . . , 229 can increase the accuracy and reliability of the computation implemented using the memory cells 207, 217, . . . , 227.

In general, a weight involving a multiplication and accumulation operation can be more than one bit. Multiple columns of memory cells can be used to store the different significant bits of weights, as illustrated in FIG. 8 to perform multiplication and accumulation operations.

The circuit illustrated in FIG. 7 can be considered a multiplier-accumulator unit configured to operate on a column of 1-bit weights and a column of 1-bit inputs. Multiple such circuits can be connected in parallel to implement a multiplier-accumulator unit to operate on a column of multi-bit weights and a column of 1-bit inputs, as illustrated in FIG. 8.

The circuit illustrated in FIG. 7 can also be used to read the data stored in the memory cells 207, 217, . . . , 227. For example, to read the data or weight stored in the memory cell 207, the input bits 211, . . . , 221 can be set to zero to cause the memory cells 217, . . . , 227 to output negligible amount of currents into the line 241 (e.g., as a bitline). The input bit 201 is set to one to cause the voltage driver 203 to apply the predetermined read voltage. Thus, the result 237 from the digitizer 233 provides the data or weight stored in the memory cell 207. Similarly, the data or weight stored in the memory cell 217 can be read via applying one as the input bit 211 and zeros as the remaining input bits in the column; and data or weight stored in the memory cell 227 can be read via applying one as the input bit 221 and zeros as the other input bits in the column.

In general, the circuit illustrated in FIG. 7 can be used to select any of the memory cells 207, 217, . . . , 227 for read or write. A voltage driver (e.g., 203) can apply a programming voltage pulse to adjust the threshold voltage of a respective memory cell (e.g., 207) to erase data, to store data or weigh, etc.

FIG. 8 shows the computation of a column of multi-bit weights multiplied by a column of input bits to provide an accumulation result according to one embodiment.

In FIG. 8, a weight 250 in a binary form has a most significant bit 257, a second most significant bit 258, . . . , a least significant bit 259. The significant bits 257, 258, . . . , 259 can be stored in memory cells 207, 206, . . . , 208 in a number of columns respectively in an array 273. The significant bits 257, 258, . . . , 259 of the weight 250 are to be multiplied by the input bit 201 represented by the voltage 205 applied on a line 281 (e.g., a wordline) by a voltage driver 203 (e.g., as in FIG. 7).

Similarly, memory cells 217, 216, . . . , 218 can be used to store the corresponding significant bits of a next weight to be multiplied by a next input bit 211 represented by the voltage 215 applied on a line 282 (e.g., a wordline) by a voltage driver 213 (e.g., as in FIG. 7); and memory cells 227, 226, . . . , 228 can be used to store corresponding of a weight to be multiplied by the input bit 221 represented by the voltage 225 applied on a line 283 (e.g., a wordline) by a voltage driver 223 (e.g., as in FIG. 7).

The most significant bits (e.g., 257) of the weights (e.g., 250) stored in the respective rows of memory cells in the array 273 are multiplied by the input bits 201, 211, . . . , 221 represented by the voltages 205, 215, . . . , 225 and then summed as the current 231 in a line 241 and digitized using a digitizer 233, as in FIG. 7, to generate a result 237 corresponding to the most significant bits of the weights.

Similarly, the second most significant bits (e.g., 258) of the weights (e.g., 250) stored in the respective rows of memory cells in the array 273 are multiplied by the input bits 201, 211, . . . , 221 represented by the voltages 205, 215, . . . , 225 and then summed as a current in a line 242 and digitized to generate a result 236 corresponding to the second most significant bits.

Similarly, the least most significant bits (e.g., 259) of the weights (e.g., 250) stored in the respective rows of memory cells in the array 273 are multiplied by the input bits 201, 211, . . . , 221 represented by the voltages 205, 215, . . . , 225 and then summed as a current in a line 243 and digitized to generate a result 238 corresponding to the least significant bit.

The most significant bit can be left shifted by one bit to have the same weight as the second significant bit, which can be further left shifted by one bit to have the same weight as the next significant bit. Thus, the result 237 generated from multiplication and summation of the most significant bits (e.g., 257) of the weights (e.g., 250) can be applied an operation of left shift 247 by one bit; and the operation of add 246 can be applied to the result of the operation of left shift 247 and the result 236 generated from multiplication and summation of the second most significant bits (e.g., 258) of the weights (e.g., 250). The operations of left shift (e.g., 247, 249) can be used to apply weights of the bits (e.g., 257, 258, . . . ) for summation using the operations of add (e.g., 246, . . . , 248) to generate a result 251. Thus, the result 251 is equal to the column of weights in the array 273 of memory cells multiplied by the column of input bits 201, 211, . . . , 221 with multiplication results accumulated.

In general, an input involving a multiplication and accumulation operation can be more than 1 bit. Columns of input bits can be applied one column at a time to the weights stored in the array 273 of memory cells to obtain the result of a column of weights multiplied by a column of inputs with results accumulated as illustrated in FIG. 9.

The circuit illustrated in FIG. 8 can be used to read the data stored in the array 273 of memory cells. For example, to read the data or weight 250 stored in the memory cells 207, 206, . . . , 208, the input bits 211, . . . , 221 can be set to zero to cause the memory cells 217, 216, . . . , 218, . . . , 227, 226, . . . , 228 to output negligible amount of currents into the line 241, 242, . . . , 243 (e.g., as bitlines). The input bit 201 is set to one to cause the voltage driver 203 to apply the predetermined read voltage as the voltage 205. Thus, the results 237, 236, . . . , 238 from the digitizers (e.g., 233) connected to the lines 241, 242, . . . , 243 provide the bits 257, 258, . . . , 259 of the data or weight 250 stored in the row of memory cells 207, 206, . . . , 208. Further, the result 251 computed from the operations of shift 247, 249, . . . and operations of add 246, . . . , 248 provides the weight 250 in a binary form.

In general, the circuit illustrated in FIG. 8 can be used to select any row of the memory cell array 273 for read. Optionally, different columns of the memory cell array 273 can be driven by different voltage drivers. Thus, the memory cells (e.g., 207, 206, . . . , 208) in a row can be programmed to write data in parallel (e.g., to store the bits 257, 258, . . . , 259) of the weight 250.

FIG. 9 shows the computation of a column of multi-bit weights multiplied by a column of multi-bit inputs to provide an accumulation result according to one embodiment.

In FIG. 9, the significant bits of inputs (e.g., 280) are applied to a multiplier-accumulator unit 270 at a plurality of time instances T, T1, . . . , T2.

For example, a multi-bit input 280 can have a most significant bit 201, a second most significant bit 202, . . . , a least significant bit 204.

At time T, the most significant bits 201, 211, . . . , 221 of the inputs (e.g., 280) are applied to the multiplier-accumulator unit 270 to obtain a result 251 of weights (e.g., 250), stored in the memory cell array 273, multiplied by the column of bits 201, 211, . . . , 221 with summation of the multiplication results.

For example, the multiplier-accumulator unit 270 can be implemented in a way as illustrated in FIG. 8. The multiplier-accumulator unit 270 has voltage drivers 271 connected to apply voltages 205, 215, . . . , 225 representative of the input bits 201, 211, . . . , 221. The multiplier-accumulator unit 270 has a memory cell array 273 storing bits of weights as in FIG. 8. The multiplier-accumulator unit 270 has digitizers 275 to convert currents summed on lines 241, 242, . . . , 243 for columns of memory cells in the array 273 to output results 237, 236, . . . , 238. The multiplier-accumulator unit 270 has shifters 277 and adders 279 connected to combine the column result 237, 236, . . . , 238 to provide a result 251 as in FIG. 8.

Similarly, at time T1, the second most significant bits 202, 212, . . . , 222 of the inputs (e.g., 280) are applied to the multiplier-accumulator unit 270 to obtain a result 253 of weights (e.g., 250) stored in the memory cell array 273 and multiplied by the vector of bits 202, 212, . . . , 222 with summation of the multiplication results.

Similarly, at time T2, the least significant bits 204, 214, . . . , 224 of the inputs (e.g., 280) are applied to the multiplier-accumulator unit 270 to obtain a result 255 of weights (e.g., 250), stored in the memory cell array 273, multiplied by the vector of bits 202, 212, . . . , 222 with summation of the multiplication results.

The result 251 generated from multiplication and summation of the most significant bits 201, 211, . . . , 221 of the inputs (e.g., 280) can be applied an operation of left shift 261 by one bit; and the operation of add 262 can be applied to the result of the operation of left shift 261 and the result 253 generated from multiplication and summation of the second most significant bits 202, 212, . . . , 222 of the inputs (e.g., 280). The operations of left shift (e.g., 261, 263) can be used to apply weights of the bits (e.g., 201, 202, . . . ) for summation using the operations of add (e.g., 262, . . . , 264) to generate a result 267. Thus, the result 267 is equal to the weights (e.g., 250) in the array 273 of memory cells multiplied by the column of inputs (e.g., 280) respectively and then summed.

A plurality of multiplier-accumulator unit 270 can be connected in parallel to operate on a matrix of weights multiplied by a column of multi-bit inputs over a series of time instances T, T1, . . . , T2.

The multiplier-accumulator units (e.g., 270) illustrated in FIG. 7, FIG. 8, and FIG. 9 can be implemented in integrated circuit devices 101 in FIG. 4, FIG. 5, and FIG. 6.

In some implementations, the memory cell array 113 in the integrated circuit devices 101 in FIG. 4, FIG. 5, and FIG. 6 has multiple layers of memory cell arrays.

FIG. 10 shows a computing system configured to process an image using an integrated circuit device and an artificial neural network according to one embodiment.

In FIG. 10, an integrated circuit device 101 has a memory chip (e.g., integrated circuit die 105) and a logic chip (e.g., integrated circuit die 109) with variations similar to the integrated circuit devices 101 of FIG. 4, FIG. 5, and FIG. 6. Optionally, the integrated circuit device 101 of FIG. 10 can have an image chip (e.g., integrated circuit die 103) as in FIG. 4, FIG. 5, or FIG. 6. Alternatively, the integrated circuit device 101 of FIG. 10 can be manufactured to have no image chip.

In FIG. 10, the interface 125 of the integrated circuit device 101 can receive commands to write an image into the integrated circuit device 101 as a memory device, or a storage device, or both.

For example, the image sensor 333 can write an image through the interconnect 331 (e.g., one or more computer buses) into the interface 125. Alternatively, a microprocessor 337 can function as a host system to retrieve an image from the image sensor 333, optionally buffer the image in the memory 335, and write the image to the interface 125. The interface 125 can place the image data in the buffer 343 as an input to the inference logic circuit 123.

In some implementations, when the integrated circuit device 101 has an image sensing pixel array 111 (e.g., as in FIG. 4, FIG. 5, and FIG. 6), the image chip or the image processing logic circuit 121 can send image data to the buffer 343 directly, or through the interface 125.

In response to the image data in the buffer 343, the inference logic circuit 123 can generate a column of inputs. The memory cell array 113 in the memory chip (e.g., integrated circuit die 105) can store an artificial neuron weight matrix 341 configured to weigh on the inputs to an artificial neural network. The inference logic circuit 123 can instruct the voltage drivers 115 to apply a column of significant bits of the inputs a time to an array of memory cells storing the artificial neuron weight matrix 341 to obtain a column of results (e.g., 251) using the technique of FIG. 8 and FIG. 9. The inference logic circuit 123 can transform the column of results (e.g., according to activation functions of artificial neurons) to generate a next column of inputs to be further weighted on using a further artificial neuron weight matrix 341. The process can continue until a last artificial neuron weight matrix 341 is applied to produce the output of the artificial neural network.

The inference logic circuit 123 can be configured to place the output of the artificial neural network into the buffer 343 for retrieval as a response to, or replacement of, the image written to the interface 125. Optionally, the inference logic circuit 123 can be configured to write the output of the artificial neural network into the memory cell array 113 in the memory chip. In some implementations, an external device (e.g., the image sensor, the microprocessor 337) writes an image into the interface 125; and in response to the integrated circuit device 101 generates the output of the artificial neural network in response to the image and write the output as a replacement of the image into the memory chip.

The memory cells in the memory cell array 113 can be non-volatile. Thus, once the weight matrices 341 are written into the memory cell array 113, the integrated circuit device 101 has the computation capability of the artificial neural network without further configuration or assistance from an external device (e.g., a host system). The computation capability can be used immediately upon supplying power to the integrated circuit device 101 without the need to boot up and configure the integrated circuit device 101 by a host system (e.g., microprocessor 337 running an operating system). The power to the integrated circuit device 101 (or a portion of it) can be turned off when the integrated circuit device 101 is not used in computing an output of an artificial neural network, and not used in reading or write data to the memory chip. Thus, the energy consumption of the computing system can be reduced.

In some implementations, the inference logic circuit 123 is programmable to perform operations of forming columns of inputs, applying the weights stored in the memory chip, and transforming columns of data (e.g., according to activation functions of artificial neurons). The instructions can also be stored in the non-volatile memory cell array 113 in the memory chip.

In some implementations, the inference logic circuit 123 includes an array of identical logic circuits configured to perform the computation of some types of activation functions, such as step activation function, rectified linear unit (ReLU) activation function, heaviside activation function, logistic activation function, gaussian activation function, multiquadratics activation function, inverse multiquadratics activation function, polyharmonic splines activation function, folding activation functions, ridge activation functions, radial activation functions, etc.

In some implementations, the multiplication and accumulation operations in an activation function are performed using multiplier-accumulator units 270 implemented using memory cells in the array 113.

Some activation functions can be implemented via multiplication and accumulation operations with fixed weights.

FIG. 11 shows another computing system according to one embodiment.

The integrated circuit device 101 in FIG. 11 has an integrated circuit die 109 with an inference logic circuit 123 and a non-volatile memory cell array 113 as in FIG. 10.

In FIG. 11, the voltage drivers 115 and the current digitizers 117 are configured in the logic chip (e.g., integrated circuit die 109 having the inference logic circuit 123). Alternatively, at least a portion of the voltage drivers 115 and the current digitizers 117 can be implemented in the memory chip (e.g., integrated circuit die 105 having the memory cell array 113).

In FIG. 11, the integrated circuit device 101 includes an image chip (e.g., integrated circuit die 103 having image sensing pixel array 111).

An image processing logic circuit 121 in the logic chip can pre-process an image from the image sensing pixel array 111 as an input to the inference logic circuit 123. After the image processing logic circuit 121 stores the input into the buffer 343, the inference logic circuit 123 can perform the computation of an artificial neural network in a way similar to the integrated circuit device 101 of FIG. 10.

For example, the inference logic circuit 123 can store the output of the artificial neural network into the memory chip in response to the input in the buffer 343.

Optionally, the image processing logic circuit 121 can also store one or more versions of the image captured by the image sensing pixel array 111 in the memory chip as a solid-state drive.

An application running in the microprocessor 337 can send a command to the interface 125 to read at a memory address in the memory chip. In response, the image sensing pixel array 111 can capture an image; the image processing logic circuit 121 can process the image to generate an input in the buffer; and the inference logic circuit 123 can generate an output of the artificial neural network responding to the input. The integrated circuit device 101 can provide the output as the content retrieved at the memory address; and the application running in the microprocessor 337 can determine, based on the output, whether to read further memory addresses to retrieve the image or the input generated by the image processing logic circuit 121. For example, the artificial neural network can be trained to generate a classification of whether the image captures an object of interest and if so, a bounding box of a portion of the image containing the image of the object and a classification of the object. Based on the output of the artificial neural network, the application running in the microprocessor 337 can decide whether to retrieve the image, or the image of the object in the bounding box, or both.

In some implementations, the original image, or the input generated by the image processing logic circuit 121, or both can be placed in the buffer 343 for retrieval by the microprocessor 337. If the microprocessor 337 decides not to retrieve the image data in view of the output of the artificial neural network, the image data in the buffer 343 can be discarded when the microprocessor 337 sends a command to the interface 125 to read a next image.

Optionally, the buffer 343 is configured with sufficient capacity to store data for up to a predetermined number of images. When the buffer 343 is full, the oldest image data in the buffer is erased.

When the integrated circuit device 101 is not in an active operation (e.g., capturing an image, operating the interface 125, or performing the artificial neural network computations), the integrated circuit device 101 can automatically enter a low power mode to avoid or reduce power consumption. A command to the interface 125 can wake up the integrated circuit device 101 to process the command.

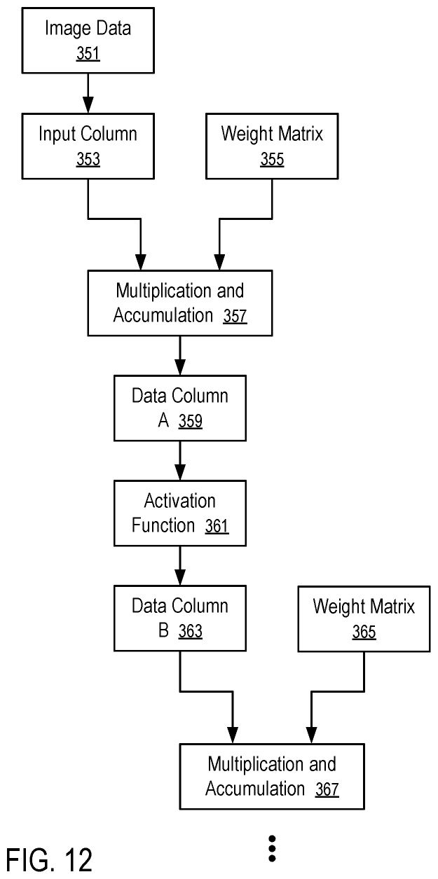

FIG. 12 shows an implementation of artificial neural network computations according to one embodiment. For example, the computations of FIG. 12 can be implemented in the integrated circuit devices 101 of FIG. 4, FIG. 5, FIG. 6, FIG. 10, and FIG. 11.

In FIG. 12, image data 351 can be provided as an input to an artificial neural network from an image sensing pixel array 111, an image processing logic circuit 121, an image sensor 333, or a microprocessor 337.

An inference logic circuit 123 in an integrated circuit device 101 can arrange the pixel values from the image data 351 into a column 353 of inputs.

A weight matrix 355 is stored in one or more layers of the memory cell array 113 in the memory chip of the integrated circuit device 101.

A multiplication and accumulation 357 combined the input columns 353 and the weight matrix 355. For example, the inference logic circuit 123 identifies the storage location of the weight matrix 355 in the memory chip, instructs the voltage drivers 115 to apply, according to the bits of the input column, voltages to memory cells storing the weights in the matrix 355, and retrieve the multiplication and accumulation results (e.g., 267) from the logic circuits (e.g., adder 264) of the multiplier-accumulator units 270 containing the memory cells.

The multiplication and accumulation results (e.g., 267) provide a column 359 of data representative of combined inputs to a set of input artificial neurons of the artificial neural network. The inference logic circuit 123 can use an activation function 361 to transform the data column 359 to a column 363 of data representative of outputs from the next set of artificial neurons. The outputs from the set of artificial neurons can be provided as inputs to a next set of artificial neurons. A weight matrix 365 includes weights applied to the outputs of the neurons as inputs to the next set of artificial neurons and biases for the neurons. A multiplication and accumulation 367 can be performed in a similar way as the multiplication and accumulation 357. Such operations can be repeated from multiple set of artificial neurons to generate an output of the artificial neural network.

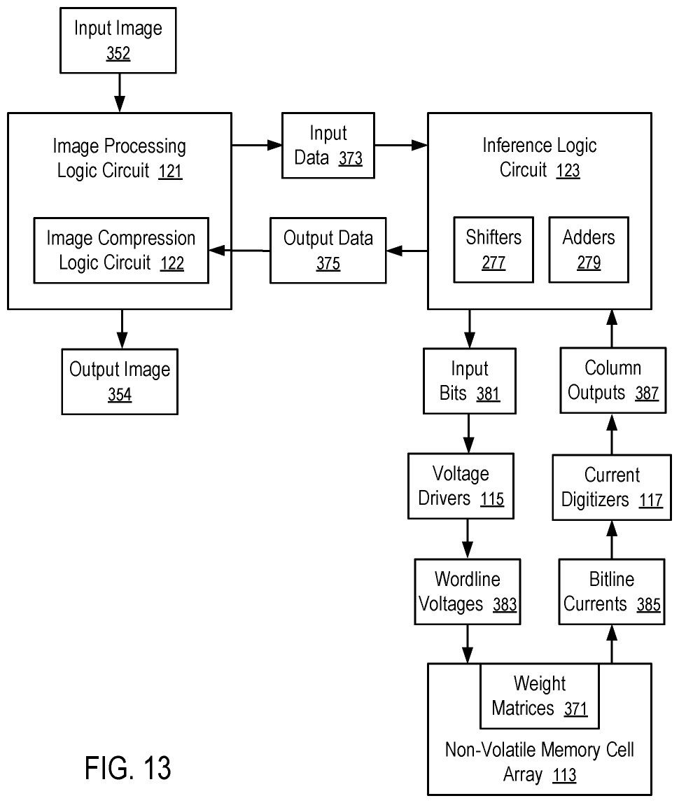

FIG. 13 shows an image processing logic circuit using an inference logic circuit in image compression according to one embodiment. For example, the technique of FIG. 13 can be implemented in integrated circuit devices 101 of FIG. 4, FIG. 5, FIG. 6, FIG. 10, and FIG. 11.

In FIG. 13, an image processing logic circuit 121 in a logic chip (e.g., integrated circuit die 109) in an integrated circuit device 101 is configured to compress an input image 352 to generate an output image 354. The image compression can include lossy compression, lossless compression, image trimming, etc.

The image compression computation can include, or formulated to include, multiplication and accumulation operations based on weight matrices 371 stored in a memory chip (e.g., integrated circuit die 105) in the integrated circuit devices 101. Preferably, the weight matrices 371 do not change for typical image compression such that the weight matrices 371 can be written into the non-volatile memory cell array 113 without repeatedly erasing and programming so that the useful life of the non-volatile memory cell array 113 can be extended. Some types of non-volatile memory cells (e.g., cross point memory) can have a high budget for erasing and programming. When the memory cells in the array 113 can tolerate a high number of erasing and programming cycles, the image compression computation can also be formulated to use weight matrices 371 that change during the computations of image compression.

The image processing logic circuit 121 can include an image compression logic circuit 122 configured to generate input data 373 for the inference logic circuit 123 to apply operations of multiplication and accumulation on weight matrices 371 to generate output data 375. The input data 373 can include, for example, pixel values of the input image 352, an identification/address of a weight matrix 371 stored in the memory cell array 113, or other data derived from the pixel values, or any combination thereof. After the operations of the multiplication and accumulation, the image processing logic circuit 121 can use the output data 375 received from the inference logic circuit 123 in compressing the input image 352 into the output image 354.

The input data 373 identifies a matrix 371 stored in the memory cell array 113 and a column of inputs (e.g., 280). In response, the inference logic circuit 123 uses a column of input bits 381 to control voltage drivers 115 to apply wordline voltages 383 onto rows of memory cells storing the weights of a matrix 371 identified by the input data 373. The voltage drivers 115 apply voltages of predetermined magnitudes on wordlines to represent the input bits 381. The memory cells in the memory cell array 113 are configured to output currents that are negligible or multiples of a predetermined amount of current 232. Thus, the combination of the voltage drivers 115 and the memory cells storing the weight matrices 371 functions as digital to analog converters configured to convert the results of bits of weights (e.g., 250) multiplied by the bits of inputs (e.g., 280) into output currents (e.g., 209, 219, . . . , 229). Bitlines (e.g., lines 241, 242, . . . , 243) in the memory cell array 113 sum the currents in an analog form. The summed currents (e.g., 231) in the bitlines (e.g., line 241) are digitized as column outputs 387 by the current digitizers 117 for further processing in a digital form (e.g., using shifters 277 and adders 279 in the inference logic circuit 123) to obtain the output data 375.

As illustrated in FIG. 7 and FIG. 8, the wordline voltages 383 (e.g., 205, 215, . . . , 225) are representative of the applied input bits 381 (e.g., 201, 211, . . . , 221) and cause the memory cells in the array 113 to generate output currents (e.g., 209, 21, . . . , 229). The memory cell array 113 connects output currents from each column of memory cells to a respective line (e.g., 241, 242, . . . , or 243) to sum the output currents for a respective column. Current digitizers 117 can determine the bitline currents 385 in the lines (e.g., bitlines) in the array 113 as multiples of a predetermined amount of current 232 to provide the summation results (e.g., 237, 236, . . . , 238) as the column outputs 387. Shifters 277 and adders 279 of the inference logic circuit 123 (or in the memory chip) can be used to combine the column outputs 387 with corresponding weights for different significant bits of weights (e.g., 250) as in FIG. 8 and with corresponding weights (e.g., 250) for the different significant bits of the inputs (e.g., 280) as in FIG. 9 to generate results of multiplication and accumulation.

The inference logic circuit 123 can provide the results of multiplication and accumulation as the output data 375. In response, the image compression logic circuit 122 can provide further input data 373 to obtain further output data 375 by combining the input data 373 with a weight matrix 371 in the memory cell array 113 through operations of multiplication and accumulation. Based on output data 375 generated by the inference logic circuit 123, the image compression logic circuit 122 converts the input image 352 into the output image 354.

For example, the input data 373 can be the pixel values of the input image 352 and an offset; and the weight matrix 371 can be applied to scale the pixel values and apply the offset.

For example, the input data 373 can be the pixel values of the input image 352; and the weight matrix 371 can be configured to compute transform coefficients of predetermined functions (e.g., cosine functions) having a sum representative of the pixel values, such as coefficients of discrete cosine transform of a spatial distribution of the pixel values. For example, the image compression logic circuit 122 can be configured to perform the computations of color space transformation, request the inference logic circuit 123 to compute the coefficients for discrete cosine transform (DCT), perform quantization of the DCT coefficients, and encode the results of quantization to generate the output image 354 (e.g., in a joint photographic experts group (JPEG or JPG) format).

For example, the input data 373 can be the pixel values of the input image 352; and the computation of an artificial neural network having the weight matrices 371 can be performed by the inference logic circuit 123 to identify one or more segments of the input image 352 containing content of interest. The image compression logic circuit 122 can adjust compression ratios for different segments of input image 352 to preserve more details in segments of interest and to compress more aggressively in other segments. Optionally, regions outside of the segments of interest can be deleted.

For example, an artificial neural network can be trained to rank the levels of interest in different segments of the input image 352. After the inference logic circuit 123 identifies the levels of interest in the output data 375 based on the computation of the artificial neural network responsive to the pixel values of the input image 352, the image compression logic circuit 122 can adjust compression ratios for different segments according to the ranked levels of interest of the segments. Optionally, the artificial neural network can be trained to predict the desired compression ratios of different segments of the input image 352.

In some implementations, a compression technique formulated using an artificial neural network is used. The output data 375 includes data representative of a compressed image; and the image compression logic circuit 122 can encode the output data 375 to provide the output image 354 according to a predetermined format.

Image enhancements and image analytics can be performed in a way similar to the image compression of FIG. 13.

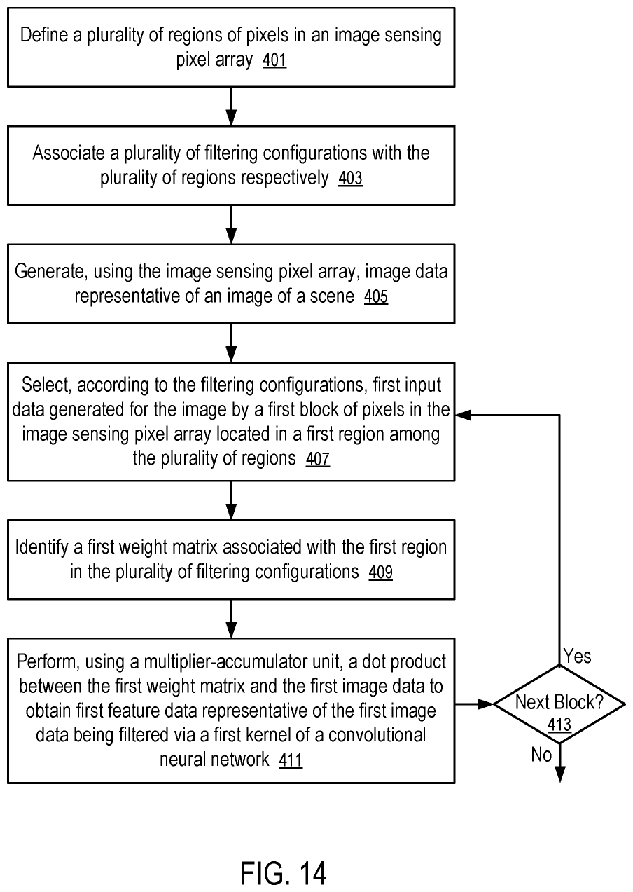

FIG. 14 shows a method of image processing according to one embodiment. For example, the method of FIG. 14 can be performed in an imaging device of FIG. 3 or an integrated circuit device 101 of FIG. 4, FIG. 5, FIG. 6, FIG. 10, or FIG. 11 using the vision techniques of FIG. 1 and FIG. 2, and using the multiplication and accumulation techniques of FIG. 7, FIG. 8, and FIG. 9.

At block 401, a plurality of regions (e.g., 11, 13) of pixels in an image sensing pixel array 111 are defined to process image data in the regions (e.g., 11, 13) with different acuity levels in machine vision.

For example, a region mask 39 can be provided to specify a set of pixels in a focal region 13 for high acuity in machine vision implemented using a convolutional neural network. Another set of pixels in the peripheral region 13 can be specified via the region mask 39 for low acuity in machine vision.

At block 403, a plurality of filtering configurations (e.g., 17, 15) are associated with the plurality of regions (e.g., 11, 13) respectively.

For example, the plurality of filtering configurations (e.g., 15, 17) can be configured to identify a plurality of kernels (e.g., 25, 27) of different kernel sizes (e.g., 21, 31) for filtering image data in the plurality of regions (e.g., 13, 11) respectively.

For example, a large kernel 35 can be configured to process the image data generated by a large block of pixels in the peripheral region 11 at a coarse-grained level. A large stride length 33 can be used to select different blocks from the peripheral region 11 for filtering by the large kernel 35.

For example, a small kernel 25 can be configured to process the image data generated by a small block of pixels in the focal region 13 at a fine-grained level. A smaller stride length 23 can be used to select different blocks from the focal region 13 for filtering by the small kernel 32.

At block 405, the image sensing pixel array 113 generates image data 19 representative of an image 10 of a scene.

For example, a scene in a production line 70 having products (e.g., 71, 73) moved passing the field of view of a lens 65 can be captured as an image 10 to be analyzed via machine vision for anomaly detection.

At block 407, a processor 61 selects, according to the filtering configurations (e.g., 17, 15), first input data (e.g., image input 29) generated for the image 10 by a first block of pixels in the image sensing pixel array 113, where the first block of pixels are located in a first region (e.g., 13) among the plurality of regions (e.g., 11, 13).

At block 409, the processor 61 identifies a first weight matrix (e.g., representative of kernel 25) associated with the first region (e.g., 13) in the plurality of filtering configurations (e.g., 15, 17).

At block 411, the processor 61 performs, using a multiplier-accumulator unit 45, a dot product between the first weight matrix (e.g., kernel data 55) and the first image data (e.g., image input 29) to obtain first feature data (e.g., result 47) representative of the first image data (e.g., image input 29) being filtered via a first kernel (e.g., 25) of a convolutional neural network.

If it is determined that, at block 413, a next block is to be processed, the operations of blocks 407 to 411 can be repeated for a second block of pixels.

For example, according to the filtering configurations (e.g., 15, 17), the processor 61 selects second image data (e.g., image input 29) generated for the image 10 by a second block of pixels in the image sensing pixel array 113, where the second block of pixels are located in a second region (e.g., 11), different from the first region (e.g., 13), among the plurality of regions (e.g., 11, 13). The processor identifies a second weight matrix (e.g., representative of kernel 35) associated with the second region (e.g., 11) in the plurality of filtering configurations (e.g., 15, 17). The processor performs a dot product between the second weight matrix (e.g., kernel data 55) and the second image data (e.g., image input 29) to obtain second feature data (e.g., result 47) representative of the second image data (e.g., image input 29) being filtered by a second kernel (e.g., 35).

For example, the first region 13 is configured to capture a central region of the image 10; the second region 11 is configured to capture a peripheral region 11 of the image 10; and the second block of pixels has a size larger than the first block of pixel.

In extracting features from the data 19 of the image 10, the central, focal region 13 of the image 10 is filtered using the first kernel 25 for fine-grained analysis but not the second kernel 35; and the peripheral region 11 is filtered using the second kernel 35 but not the first kernel 25.

The plurality of filtering configurations (e.g., 15, 17) can further identify a plurality of stride lengths (e.g., 23, 33) for filtering within the plurality of regions (e.g., 13, 11) respectively. The processor 61 is further configured to filter blocks of image data 19 selected within the first region 13 according to a first stride length 23 and filter blocks of image data 19 selected from the second region 11 according to a second stride length 33 larger than the first stride length 23.

The processor 61 can be configured to quantize the image input 29 of a block of image data 19 (e.g., selected from the first region 13 or the second region 11) to generate quantized input data 49 for a dot product with the kernel data 55 of the corresponding region (e.g., 13 or 11) in a multiplier-accumulator unit 45.

Optionally, the plurality of filtering configurations (e.g., 15, 17) can further identify a plurality of quantization levels for filtering within the plurality of regions (e.g., 13, 11) respectively. For example, the processor 61 can quantize the first image data selected from the first region 13 at a first precision level as an input to the multiplier-accumulator unit 45, and quantize the second image data selected from the second region 11 at a second precision level, lower than the first precision level.

For example, the image sensing pixel array 113 can be configured in a first integrated circuit die 103 to generate the data 19 of the image 10. A second integrated circuit die 105 can have a memory cell array 113 configured to store a first weight matrix representative of the first kernel 25 of the convolutional neural network and a second weight matrix representative of the second kernel 35. A third integrated circuit die 109 can be a logic circuit 123 configured to implement at least a portion of the processor 61.

For example, the logic circuit 123 can be configured to apply the first kernel 25 to the first region 13 using the first weight matrix to generate first feature data, and apply the second kernel 35 to the second region 11 using the second weight matrix to generate second feature data.

Optionally, the second integrated circuit die 105 and the third integrated circuit die 109 are configured in an integrated circuit device 101, connected via a direct bond interconnect 107, and enclosed within a single integrated circuit package.

Optionally, the first integrated circuit die 103 is also included in the integrated circuit device 101. Alternatively, the first integrated circuit die 103 is configured in an image sensor 333 outside of the integrated circuit device 101.

Optionally, the processor 61 is implemented at least in part via a microprocessor 337 outside of the integrated circuit device 101 having the memory cell array 113.

Each respective memory cell in the memory cell array 113 in the integrated circuit device 101 is programmable in a synapse mode and programmable in a storage mode. When programmed in the synapse mode, the respective memory cell can output: a predetermined amount of current in response to a predetermined read voltage when the respective memory cell has a threshold voltage programmed to represent a value of one; or a negligible amount of current in response to the predetermined read voltage when the threshold voltage is programmed to represent a value of zero. When programmed in the storage mode, the respective memory cell have a threshold voltage positioned in one of a plurality of voltage regions, each representative of one of a plurality of predetermined values.

The integrated circuit device 101 includes voltage drivers 115 and current digitizers 117. A portion of the memory cell array 113 configured to store the first weight matrix and the second weight matrix has memory cells programmed in the synapse mode, wordlines 281, 282, . . . , 283, and bitlines 241, 242, . . . , 243. The logic circuit 123 can perform an operation of multiplication and accumulation using the memory cells programmed in the synapse mode. For example, the logic circuit 123 can convert, using the voltage drivers 115 connected to the wordlines 281, 282, . . . , 283 and into output currents of the memory cells summed in the bitlines 241, 242, . . . , 243, results of bitwise multiplications of bits in an input and bits stored in the memory cells. The logic circuit 123 can digitize, using the current digitizers 117 connected to the bitlines 241, 242, . . . , 243, currents in the bitlines 241, 242, . . . , 243 to obtain column outputs. The logic circuit 123 can generate, from the column outputs, results of the operation of multiplication and accumulation applied to the input and weight data stored in the memory cells.

The memory cell array 113 can be configured to store a region mask 39 to identify the first region 13 within the image 10 and the second region 11 within the image 10. The logic circuit 123 can be configured to select, according to the region mask 39, the first kernel 25 and the second kernel 35 to filter the first region 13 and the second region 11 in generation of the first feature data and the second feature data.

The processor 61 can use a communication device 339 to communicate the first feature data and the second feature data to a remote server system that is configured to detect anomalies in the image 10 based on the first feature data and the second feature data.

In some implementations, the logic circuit 123 in the integrated circuit device 101 is configured to apply the first kernel 25 in the first region 13 according to a first stride length 23 and apply the second kernel 35 in the second region 11 according to a second stride length 33 different from (e.g., larger than) the first stride length 23.

Optionally, the logic circuit 123 is configured to apply quantization 43 of image data 19 from the first region 13 according at a first precision level and apply quantization 43 of image data 19 from the second region 11 according to a second precision level different from (e.g., lower than) the first precision level.

For example, an apparatus to generate feature data of the image 10 can include an image sensor 333 (or an image sensing pixel array 111), a lens 65 configured to project the image 10 onto the image sensor 333, a storage device (e.g., memory cell array 113), a communication device 339, and a processor 61. The storage device is configured to store a region mask 39 configured to identify a focal region 13 of the image 10 and a peripheral region 11 of the image 10. The storage device is further configured to store a first kernel 25 of a convolutional neural network, and a second kernel 35. The processor 61 can be implemented via the logic circuit 123 and/or a microprocessor 337 to apply, according to the region mask 39, the first kernel 25 to the focal region 13 to generate the first feature data and apply, according to the region mask 39, the second kernel 35 to the peripheral region 11 to generate the second feature data.

In some implementations, the processor 61 is further configured to recognize anomaly in the image 10 based on the first feature data and the second feature data. Alternatively, the processor is further configured to communicate, using the communication device 339, the first feature data and the second feature data to a remote server system that can recognize anomaly in the image 10 based on the first feature data and the second feature data.

Integrated circuit devices 101 (e.g., as in FIG. 4, FIG. 5, FIG. 6, FIG. 10, and FIG. 11) can be configured as a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The integrated circuit devices 101 (e.g., as in FIG. 4, FIG. 5, FIG. 6, FIG. 10, and FIG. 11) can be installed in a computing system as a memory sub-system having an embedded image sensor and an inference computation capability. Such a computing system can be a computing device such as a desktop computer, a laptop computer, a network server, a mobile device, a portion of a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

In general, a computing system can include a host system that is coupled to one or more memory sub-systems (e.g., integrated circuit device 101 of FIG. 4, FIG. 5, FIG. 6, FIG. 10, and FIG. 11). In one example, a host system is coupled to one memory sub-system. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system can include a processor chipset (e.g., processing device) and a software stack executed by the processor chipset. The processor chipset can include one or more cores, one or more caches, a memory controller (e.g., NVDIMM controller), and a storage protocol controller (e.g., PCIe controller, SATA controller). The host system uses the memory sub-system, for example, to write data to the memory sub-system and read data from the memory sub-system.

The host system can be coupled to the memory sub-system via a physical host interface. Examples of a physical host interface include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface can be used to transmit data between the host system and the memory sub-system. The host system can further utilize an NVM express (NVMe) interface to access components (e.g., memory devices) when the memory sub-system is coupled with the host system by the PCIe interface. The physical host interface can provide an interface for passing control, address, data, and other signals between the memory sub-system and the host system. In general, the host system can access multiple memory sub-systems via a same communication connection, multiple separate communication connections, or a combination of communication connections.

The processing device of the host system can be, for example, a microprocessor, a central processing unit (CPU), a processing core of a processor, an execution unit, etc. In some instances, the controller can be referred to as a memory controller, a memory management unit, or an initiator. In one example, the controller controls the communications over a bus coupled between the host system and the memory sub-system. In general, the controller can send commands or requests to the memory sub-system for desired access to memory devices. The controller can further include interface circuitry to communicate with the memory sub-system. The interface circuitry can convert responses received from the memory sub-system into information for the host system.

The controller of the host system can communicate with the controller of the memory sub-system to perform operations such as reading data, writing data, or erasing data at the memory devices, and other such operations. In some instances, the controller is integrated within the same package of the processing device. In other instances, the controller is separate from the package of the processing device. The controller or the processing device can include hardware such as one or more integrated circuits (ICs), discrete components, a buffer memory, or a cache memory, or a combination thereof. The controller or the processing device can be a microcontroller, special-purpose logic circuitry (e.g., a field programmable gate array (FPGA), an application specific integrated circuit (ASIC), etc.), or another suitable processor.

The memory devices can include any combination of the different types of non-volatile memory components and volatile memory components. The volatile memory devices can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, or a PLC portion of memory cells, or any combination thereof. The memory cells of the memory devices can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller (or controller for simplicity) can communicate with the memory devices to perform operations such as reading data, writing data, or erasing data at the memory devices and other such operations (e.g., in response to commands scheduled on a command bus by controller). The controller can include hardware such as one or more integrated circuits (ICs), discrete components, or a buffer memory, or a combination thereof. The hardware can include digital circuitry with dedicated (i.e., hard-coded) logic to perform the operations described herein. The controller can be a microcontroller, special-purpose logic circuitry (e.g., a field programmable gate array (FPGA), an application specific integrated circuit (ASIC), etc.), or another suitable processor.

The controller can include a processing device (processor) configured to execute instructions stored in a local memory. In the illustrated example, the local memory of the controller includes an embedded memory configured to store instructions for performing various processes, operations, logic flows, and routines that control operation of the memory sub-system, including handling communications between the memory sub-system and the host system.

In some embodiments, the local memory can include memory registers storing memory pointers, fetched data, etc. The local memory can also include read-only memory (ROM) for storing micro-code. While the example memory sub-system includes a controller, in another embodiment of the present disclosure, a memory sub-system does not include a controller, and can instead rely upon external control (e.g., provided by an external host, or by a processor or controller separate from the memory sub-system).

In general, the controller can receive commands or operations from the host system and can convert the commands or operations into instructions or appropriate commands to achieve the desired access to the memory devices. The controller can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices. The controller can further include host interface circuitry to communicate with the host system via the physical host interface. The host interface circuitry can convert the commands received from the host system into command instructions to access the memory devices as well as convert responses associated with the memory devices into information for the host system.

The memory sub-system can also include additional circuitry or components that are not illustrated. In some embodiments, the memory sub-system can include a cache or buffer (e.g., DRAM) and address circuitry (e.g., a row decoder and a column decoder) that can receive an address from the controller and decode the address to access the memory devices.

In some embodiments, the memory devices include local media controllers that operate in conjunction with the memory sub-system controller to execute operations on one or more memory cells of the memory devices. An external controller (e.g., memory sub-system controller) can externally manage the memory device (e.g., perform media management operations on the memory device). In some embodiments, a memory device is a managed memory device, which is a raw memory device combined with a local media controller for media management within the same memory device package. An example of a managed memory device is a managed NAND (MNAND) device.

The controller or a memory device can include a storage manager configured to implement storage functions discussed above. In some embodiments, the controller in the memory sub-system includes at least a portion of the storage manager. In other embodiments, or in combination, the controller or the processing device in the host system includes at least a portion of the storage manager. For example, the controller, the controller, or the processing device can include logic circuitry implementing the storage manager. For example, the controller, or the processing device (processor) of the host system, can be configured to execute instructions stored in memory for performing the operations of the storage manager described herein. In some embodiments, the storage manager is implemented in an integrated circuit chip disposed in the memory sub-system. In other embodiments, the storage manager can be part of firmware of the memory sub-system, an operating system of the host system, a device driver, or an application, or any combination therein.

In one embodiment, an example machine of a computer system within which a set of instructions, for causing the machine to perform any one or more of the methods discussed herein, can be executed. In some embodiments, the computer system can correspond to a host system that includes, is coupled to, or utilizes a memory sub-system or can be used to perform the operations described above. In alternative embodiments, the machine can be connected (e.g., networked) to other machines in a LAN, an intranet, an extranet, or the internet, or any combination thereof. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, a network-attached storage facility, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system includes a processing device, a main memory (e.g., read-only memory (ROM), flash memory, dynamic random access memory (DRAM) such as synchronous DRAM (SDRAM) or Rambus DRAM (RDRAM), static random access memory (SRAM), etc.), and a data storage system, which communicate with each other via a bus (which can include multiple buses).

Processing device represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device can also be one or more special-purpose processing devices such as an application specific integrated circuit (ASIC), a field programmable gate array (FPGA), a digital signal processor (DSP), network processor, or the like. The processing device is configured to execute instructions for performing the operations and steps discussed herein. The computer system can further include a network interface device to communicate over the network.

The data storage system can include a machine-readable medium (also known as a computer-readable medium) on which is stored one or more sets of instructions or software embodying any one or more of the methodologies or functions described herein. The instructions can also reside, completely or at least partially, within the main memory and within the processing device during execution thereof by the computer system, the main memory and the processing device also constituting machine-readable storage media. The machine-readable medium, data storage system, or main memory can correspond to the memory sub-system.

In one embodiment, the instructions include instructions to implement functionality corresponding to the operations described above. While the machine-readable medium is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special-purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
defining a plurality of regions of pixels in an image sensing pixel array;
associating a plurality of filtering configurations with the plurality of regions respectively;
generating, using the image sensing pixel array, image data representative of an image of a scene;
selecting, according to the filtering configurations, first input data generated for the image by a first block of pixels in the image sensing pixel array located in a first region among the plurality of regions;
identifying a first weight matrix associated with the first region in the plurality of filtering configurations; and
performing, using a multiplier-accumulator unit, a dot product between the first weight matrix and the first image data to obtain first feature data representative of the first image data being filtered via a first kernel of a convolutional neural network.

2. The method of claim 1, wherein the plurality of filtering configurations identify a plurality of kernels of different kernel sizes for the plurality of regions respectively.

3. The method of claim 2, further comprising:
selecting, according to the filtering configurations, second image data generated for the image by a second block of pixels in the image sensing pixel array located in a second region, different from the first region, among the plurality of regions;
identifying a second weight matrix associated with the second region in the plurality of filtering configurations; and
performing a dot product between the second weight matrix and the second image data to obtain second feature data representative of the second image data being filtered by a second kernel.

4. The method of claim 3, wherein the first region is configured to capture a central region of the image; the second region is configured to capture a peripheral region of the image; and the second block of pixels has a size larger than the first block of pixel.

5. The method of claim 4, wherein the central region of the image filtered using the first kernel but not the second kernel; and the peripheral region is filtered using the second kernel but not the first kernel.

6. The method of claim 4, wherein the plurality of filtering configurations further identify a plurality of stride lengths for filtering within the plurality of regions respectively; and the method further comprises:
filtering the first region according to a first stride length;
filtering the second region according to a second stride length larger than the first stride length.

7. The method of claim 6, wherein the plurality of filtering configurations further identify a plurality of quantization levels for filtering within the plurality of regions respectively; and the method further comprises:
quantizing the first image data at a first precision level as an input to the multiplier-accumulator unit; and
quantizing the second image data at a second precision level, lower than the first precision level.

8. A device, comprising:
a first integrated circuit die having an image sensing pixel array configured to generate image data representative of an image of a scene, the image having a first region and a second region;
a second integrated circuit die having a memory cell array configured to store a first weight matrix representative of a first kernel of a convolutional neural network and a second weight matrix representative of a second kernel; and
a third integrated circuit die having a logic circuit configured to:
apply the first kernel to the first region using the first weight matrix to generate first feature data; and
apply the second kernel to the second region using the second weight matrix to generate second feature data.

9. The device of claim 8, further comprising:
an integrated circuit package configured to enclose at least the second integrated circuit die and the third integrated circuit die.

10. The device of claim 9, wherein the memory cell array is further configured to store a region mask configured to identify the first region within the image and the second region within the image; and the logic circuit is further configured to select, according to the region mask, the first kernel and the second kernel to filter the first region and the second region in generation of the first feature data and the second feature data.

11. The device of claim 10, further comprising:
a communication device configured to communicate the first feature data and the second feature data to a remote server system.

12. The device of claim 11, wherein the logic circuit is configured to apply the first kernel in the first region according to a first stride length and apply the second kernel in the second region according to a second stride length different from the first stride length.

13. The device of claim 12, wherein the logic circuit is configured to apply quantization of image data from the first region according at a first precision level and apply quantization of image data from the second region according to a second precision level different from the first precision level.

14. The device of claim 13, further comprising:
voltage drivers; and
current digitizers;
wherein a portion of the memory cell array configured to store the first weight matrix and the second weight matrix includes memory cells programmed in a synapse mode, wordlines, and bitlines;
wherein the logic circuit is configured to perform an operation of multiplication and accumulation using the memory cells programmed in the synapse mode; and
wherein the logic circuit is configured to:
convert, using the voltage drivers connected to the wordlines and into output currents of the memory cells summed in the bitlines, results of bitwise multiplications of bits in an input and bits stored in the memory cells;
digitize, using the current digitizers connected to the bitlines, currents in the bitlines to obtain column outputs; and
generate, from the column outputs, results of the operation of multiplication and accumulation applied to the input and weight data stored in the memory cells.

15. The device of claim 14, wherein each respective memory cell in the memory cell array is:
programmable in the synapse mode to output:
a predetermined amount of current in response to a predetermined read voltage when the respective memory cell has a threshold voltage programmed to represent a value of one; or
a negligible amount of current in response to the predetermined read voltage when the threshold voltage is programmed to represent a value of zero; and
programmable in a storage mode to have a threshold voltage positioned in one of a plurality of voltage regions, each representative of one of a plurality of predetermined values.

16. An apparatus, comprising:
an image sensor;
a lens configured to project an image onto the image sensor;
a storage device configured to store:
a region mask configured to identify a focal region of the image and a peripheral region of the image;
a first kernel of a convolutional neural network; and
a second kernel;
a communication device; and
a processor configured to:
apply, according to the region mask, the first kernel to the focal region to generate first feature data; and
apply, according to the region mask, the second kernel to the peripheral region to generate second feature data.

17. The apparatus of claim 16, wherein the processor is further configured to recognize anomaly in the image based on the first feature data and the second feature data.

18. The apparatus of claim 16, wherein the processor is further configured to communicate, using the communication device, the first feature data and the second feature data to a remote server system configured to recognize anomaly in the image based on the first feature data and the second feature data.

19. The apparatus of claim 16, wherein the processor is configured to apply the first kernel in the focal region according to a first stride length and apply the second kernel in the peripheral region according to a second stride length larger than the first stride length.

20. The apparatus of claim 19, wherein the processor is configured to quantize image data from the focal region at a first precision level and quantize image data from the peripheral region at a second precision level lower than the first precision level.
